(19) United States
(12) Patent Application Publication
(10) Pub. No.: US 2023/0324611 A1
(43) Pub. Date: Oct. 12, 2023

(54) OPTICAL CIRCUIT BOARD

(71) Applicant: KYOCERA Corporation, Kyoto-shi, Kyoto (JP)

(72) Inventor: Itsuroh SHISHIDO, Otsu-shi, Shiga (JP)

(73) Assignee: KYOCERA Corporation, Kyoto-shi, Kyoto (JP)

(21) Appl. No.: 18/023,596

(22) PCT Filed: Aug. 2, 2021
(86) PCT No.: PCT/JP2021/028564

§ 371 Date: Feb. 27, 2023

(30) Foreign Application Priority Data
Aug. 28, 2020 (JP) 2020-144510

(51) Int. Cl. G02B 6/13; G02B 6/122; G02B 6/42

(52) U.S. Cl. CPC G02B 6/13; G02B 6/122; G02B 6/42

(57) ABSTRACT

An optical circuit board according to the present disclosure includes: an optical waveguide plate provided with a base member, an optical waveguide located on an upper surface of the base member, and a leg located on a lower surface of the base member; and a wiring board provided with an insulating plate, a fitting portion located on an upper surface of the insulating plate for fitting with the leg, and an electrode located on the upper surface of the insulating plate and electrically connected to an optical component. The leg of the optical waveguide plate is fitted into the fitting portion of the wiring board, and there is a gap between a lower surface of the optical waveguide plate and an upper surface of the wiring board.

### TECHNICAL FIELD

The present invention relates to an optical circuit board.

### BACKGROUND OF INVENTION

Optical communication networks capable of communicating large amounts of data at high speed have been expanding in recent years, and there are various optical communication devices utilizing such optical communication networks. Such devices are equipped with an optical circuit board in which an optical waveguide is connected to a wiring board as described in, for example, Patent Document 1. Such an optical circuit board is generally obtained by mounting an optical waveguide on an organic board (base board) as a wiring board.

However, the presence of a warp, waviness, or the like in an organic board makes it difficult to mount an optical waveguide on such an organic board without adversely affecting flatness and positional accuracy. As a result, position adjustment (alignment of optical axes) between the mounted optical waveguide and an optical component to be mounted on a wiring board becomes difficult, and thus there arises a risk that the optical transmission characteristics of the optical component in combination with the optical waveguide may be degraded.

In order to improve the flatness, an optical waveguide (optical waveguide plate) equipped with a base member where the optical waveguide is formed on glass may be mounted on an organic board of a wiring board. However, the optical waveguide plate mounted on the wiring board is likely to be affected by thermal expansion and contraction of the wiring board, and therefore there is a risk that cracking may occur in the optical waveguide plate.

### CITATION LIST

### Patent Literature

Patent Document 1: JP 2006-53579 A

### SUMMARY

### Solution To Problem

An optical circuit board according to the present disclosure includes: an optical waveguide plate provided with a base member, an optical waveguide located on an upper surface of the base member, and a leg located on a lower surface of the base member; and a wiring board provided with an insulating plate, a fitting portion located on an upper surface of the insulating plate for fitting with the leg, and an electrode located on the upper surface of the insulating plate and to be electrically connected to an optical component. The leg of the optical waveguide plate is fitted into the fitting portion of the wiring board, and there is a gap between the lower surface of the optical waveguide plate and the upper surface of the wiring board.

### BRIEF DESCRIPTION OF THE DRAWINGS

FIG. 1A is an explanatory diagram illustrating a mounting structure including an optical circuit board according to an embodiment of the present disclosure, FIG. 1B illustrates a schematic diagram of an optical waveguide plate included in FIG. 1A when viewed from an upper surface thereof, and FIG. 1C is a schematic diagram of a wiring board included in FIG. 1A when viewed from an upper surface thereof.

FIG. 2 is an explanatory diagram illustrating a mounting structure including an optical circuit board according to another embodiment of the present disclosure.

FIG. 3A is an explanatory diagram illustrating a variation of a leg provided in an optical waveguide plate, FIG. 3B is an explanatory diagram illustrating a variation of a first opening, and FIG. 3C is an explanatory diagram illustrating a variation of a third opening.

FIG. 4 is an explanatory diagram illustrating an optical waveguide plate including a connector.

### DESCRIPTION OF EMBODIMENTS

As described above, in an optical circuit board of the related art, the position adjustment (alignment of optical axes) between the mounted optical waveguide and an optical component to be mounted on a wiring board is difficult to perform, and thus there arises a risk that the optical transmission characteristics of the optical component in combination with the optical waveguide may be degraded. The optical waveguide plate mounted on the wiring board is likely to be affected by thermal expansion and contraction of the wiring board, and therefore there is a risk that cracking may occur in the optical waveguide plate. Accordingly, there is a demand for an optical circuit board capable of suppressing the occurrence of cracking in the mounted optical waveguide plate and excellent in positional accuracy between an optical waveguide plate to be mounted and an optical component to be mounted.

In an optical circuit according to the present disclosure, a leg of an optical waveguide plate is fitted into a fitting portion of the wiring board, and there is a gap between a lower surface of the optical waveguide plate and an upper surface of the wiring board. Because of this, according to the present disclosure, an optical circuit board capable of suppressing the occurrence of cracking in the mounted optical waveguide plate and excellent in positional accuracy between an optical waveguide plate to be mounted and an optical component to be mounted may be provided.

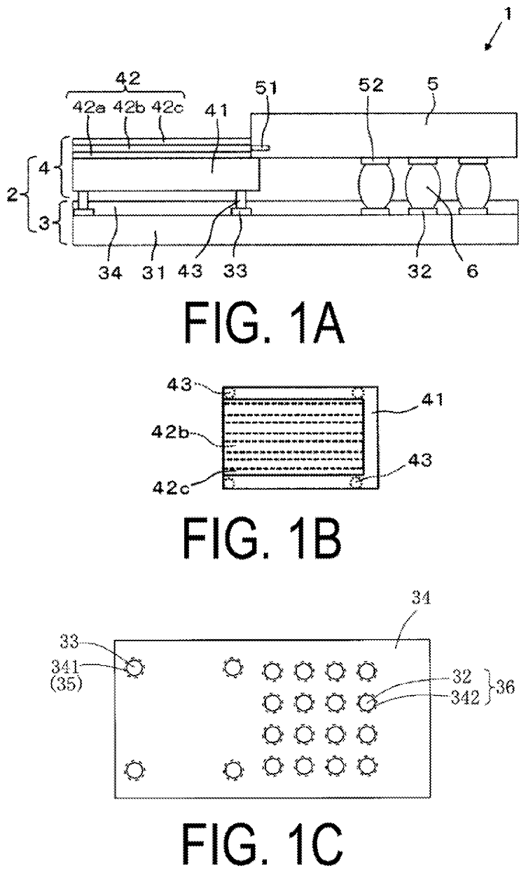

An optical circuit board according to an embodiment of the present disclosure will be described based on FIG. 1. FIG. 1A is an explanatory diagram illustrating a mounting structure 1 including an optical circuit board 2 according to an embodiment of the present disclosure. The optical circuit board 2 according to the embodiment illustrated in FIG. 1A includes a wiring board 3 and an optical waveguide plate 4.

The wiring board 3 will be described first. The wiring board 3 includes an insulating plate 31, an electrode 32, a support member 33, and a solder resist 34. The insulating plate 31 is not particularly limited as long as it is made of a material having an insulating property. Examples of the material having an insulating property include resins such as an epoxy resin, a bismaleimide-triazine resin, a polyimide resin, and a polyphenylene ether resin. Two or more of these resins may be mixed and used.

The insulating plate 31 may contain a reinforcing material. Examples of the reinforcing material include insulating fabric materials such as glass fiber, glass non-woven fabric, aramid non-woven fabric, aramid fiber, and polyester fiber. Two or more types of reinforcing materials may be used in combination. Inorganic insulating fillers made of, for example, silica, barium sulfate, talc, clay, glass, calcium carbonate, or titanium oxide may be dispersed in the insulating plate 31.

The insulating plate 31 illustrated in FIG. 1A has a single-layer structure having only a core layer. However, it may have a build-up structure in which an insulation layer and an electrical conductor layer are alternately layered on at least one surface of the core layer having an insulating property. Although not illustrated in FIG. 1A, a through-hole conductor used for electrically connecting the upper and lower surfaces of the insulating plate 31, a via-hole conductor used for electrically connecting layers in a build-up structure, and the like are usually formed.

The electrode 32 and the support member 33 are located on the surface of the insulating plate 31. The electrode 32 is made of a metal such as copper and is used for connecting electrically with an optical component 5 described below. The support member 33 is used to support a leg 43 provided on the optical waveguide plate 4 described below. Similar to the electrode 32, the leg 43 is also made of a metal such as copper. The support member 33 is not necessarily required in the wiring board 3. The support member 33 may be appropriately disposed when the length of the leg 43 needs to be shortened by raising the position where a bottom portion of the leg 43 described below comes into contact with the support member 33.

In the wiring board 3 illustrated in FIG. 1A, the solder resist 34 is located to cover the surface of the insulating plate 31. The solder resist 34 is made of, for example, an acrylic-modified epoxy resin. As illustrated in FIG. 1C, a first opening 341 for exposing the support member 33 and a second opening 342 for exposing the electrode 32 are formed in the solder resist 34. The first opening 341 functions as a fitting portion 35, into which the leg 43 of the optical waveguide plate 4 is inserted. The second opening 342 functions as a connecting portion 36 configured to connect the electrode 32 and an electrode 52 of the optical component 5 with solder 6. FIG. 1C illustrates a schematic diagram of the wiring board 3 when viewed from the upper surface thereof.

The optical waveguide plate 4 will be described. The optical waveguide plate 4 includes a base member 41, an optical waveguide 42, and the leg 43. The base member 41 is made of, for example, glass, resin, or the like, and is preferably made of a substance having optical transparency. The size of the base member 41 is not limited as long as the optical waveguide 42 can be formed on the upper surface thereof. For example, as illustrated in FIG. 1B, the size of the base member 41 is such that at least part of the peripheral edge portion of the base member 41 is exposed without being covered with the optical waveguide 42 in a top surface view of the optical waveguide plate 4. When exposed as discussed above, the formation of the leg 43 described below is carried out with ease. The width of the peripheral edge portion is appropriately set in accordance with the size of the diameter of the leg 43 and is approximately set to be in a range from 0.5 mm to 10 mm from the end portion, for example.

In particular, the peripheral edge portion on the side where the optical component 5 described below is mounted is preferably not covered with the optical waveguide 42 but exposed. With such a configuration, part of the optical component 5 may be mounted on the peripheral edge portion of the base member 41. This makes it possible to easily position a light transmitting/receiving portion 51 of the optical component 5 and a core 42b in the height direction.

The optical waveguide 42 is located on the upper surface of the base member 41. A lower cladding layer 41a is located at the upper surface side of the base member 41, and the core 42b is located on the upper surface of the lower cladding layer 42a. An upper cladding layer 42c covers the upper surface of the lower cladding layer 42a and the core 42b.

The core 42b included in the optical waveguide 42 acts as a light path, and light that has entered the optical waveguide 42 is transmitted while being refracted repeatedly at the side surfaces and the upper and lower surfaces of the core 42b. The material forming the core 42b is not limited thereto, and is appropriately set in consideration of, for example, optical transparency, wavelength characteristics of the light that passes therethrough, and the like. Examples of the material include an epoxy resin and a polyimide resin. The core 42b may have a thickness of 1 μm or more and 100 μm or less, and a width of 1 μm or more and 100 μm or less, for example.

The materials forming the lower cladding layer 42a and the upper cladding layer 42c are not limited thereto, and examples thereof include an epoxy resin and a polyimide resin. The lower cladding layer 42a and the upper cladding layer 42c may each have a thickness of, for example, 1 μm or more and 100 μm or less. The lower cladding layer 42a and the upper cladding layer 42c may have the same thickness or may have different thicknesses.

The light having entered into the core 42b is transmitted while being refracted repeatedly at a boundary between the core 42b and the lower cladding layer 42a and a boundary between the core 42b and the upper cladding layer 42c. Accordingly, the resin forming the core 42b has an index of refraction larger than indices of refraction of the resins forming the lower cladding layer 42a and the upper cladding layer 42c.

The leg 43 is located on the lower surface of the base member 41. The leg 43 is used to fix the optical waveguide plate 4 while securing a gap between the optical waveguide plate 4 and the wiring board 3. Specifically, the leg 43 is inserted into the first opening 341 formed in the solder resist 34 included in the wiring board 3, and the optical waveguide plate 4 is mounted on the upper surface of the wiring board 3. The leg 43 may be made of resin or the like, for example, and may be made of the same resin as that of the core 42b.

The diameter of the leg 43 is not limited as long as the leg 43 can be inserted into the first opening 341. From the viewpoint of insertion ease and positioning accuracy, the diameter of the leg 43 is preferably smaller in size than the diameter of the first opening 341 by about 1 μm or more and about 3 μm or less. The length of the leg 43 is not limited as long as the length of the leg 43 allows a gap to be present between the upper surface of the wiring board 3 and the lower surface of the optical waveguide plate 4, and allows the mounting of the optical waveguide plate 4 on the wiring board 3 to be carried out, the height of the core 42b included in the optical waveguide 42 being matched with the height of the light transmitting/receiving portion 51 of the optical component 5 described below. Since the gap is present between the upper surface of the wiring board 3 and the lower surface of the optical waveguide plate 4, the upper surface of the wiring board 3 and the lower surface of the base member 41 of the optical waveguide plate 4 are not in contact with each other. Because of this, the base member 41 is unlikely to be affected by deformation due to thermal expansion and contraction, such as a warp or waviness generated in the wiring board 3. As a result, the occurrence of cracking in the optical waveguide plate 4 may be suppressed. From the viewpoint of reducing the influence of such deformation, the gap may be preferably 10 μm or more per 10 mm length of the optical waveguide 42, for example. Note that the gap is determined depending on the length of the optical waveguide 42. The leg 43 and the fitting portion 35 may be reinforced by using an adhesive. The gap may be filled with an elastic adhesive. The elastic adhesive may have a tensile elastic modulus of 1 N/mm² or more and 100 N/mm² or less.

In the mounting structure 1 according to the embodiment of the present disclosure illustrated in FIG. 1A, the optical component 5 is mounted on the optical circuit board 2 including the wiring board 3 and the optical waveguide plate 4. The optical component 5 includes the light transmitting/receiving portion 51 on at least one side surface thereof. The light transmitting/receiving portion 51 is a member that transmits an optical signal from the optical component 5 or a member that causes the optical component 5 to receive an optical signal. Since the member for transmission differs from the member for reception, and the member for transmission or the member for reception is selected in accordance with the optical component 5, the description “light transmitting/receiving portion” is used for convenience as a term indicating both transmission and reception.

In the optical component 5, a lower surface of a portion where the light transmitting/receiving portion 51 is present is mounted on the peripheral edge portion of the base member 41 of the optical waveguide plate 4 as described above. In other words, the lower surface of the portion where the light transmitting/receiving portion 51 is present and the upper surface of the base member 41 of the optical waveguide plate 4 are in contact with each other. With this configuration, as described above, the positions in the height direction of the core 42b of the optical waveguide 42 and the light transmitting/receiving portion 51 of the optical component 5 may be accurately determined.

The optical component 5 is electrically connected to the wiring board 3. Specifically, the electrode 52 included in the optical component 5 and the electrode 32 included in the wiring board 3 are electrically connected to each other via the solder 6.

A method for manufacturing the optical circuit board 2 according to an embodiment will be described. The method for manufacturing the optical circuit board 2 according to the embodiment includes a step of forming the optical waveguide plate 4, a step of forming the wiring board 3, and a step of mounting the optical waveguide plate 4 on the wiring board 3.

The step of forming the optical waveguide plate 4 will be described. First, the base member 41 having optical transparency such as glass or resin is prepared. Then, the optical waveguide 42 is formed on the upper surfaces of the base member 41. To be specific, a material for the lower cladding layer 42a is adhered on the upper surface of the base member 41. Examples of the material for the lower cladding layer 42a include a resin film made of an epoxy resin, a polyimide resin or the like, and a resin paste. After the adhesion of such material, masking, exposure, and development are performed as necessary to form the lower cladding layer 42a.

Then, a photosensitive material for the core 42b is adhered on the upper surface of the lower cladding layer 42a. Examples of the photosensitive material for the core 42b include a resin film made of an epoxy resin, a polyimide resin or the like, and a resin paste. When adhering the photosensitive material for the core 42b, the material for the core 42b is not adhered to a position overlapping the portion where the leg 43 is to be formed in a plane perspective view. Then, a photosensitive material for the leg 43 is adhered on the lower surface of the base member 41. The material for the leg 43 is preferably a material having such photosensitivity and development properties that allow the material to be exposed at the same quantity of light and developed by the same developer as the material for the core 42b; the material for the leg 43, and the material for the core 42b may be the same.

After the material for the core 42b and the material for the leg 43 are adhered, masking, exposure, and development are performed. Specifically, first, a mask having openings corresponding to the pattern of the core 42b and the pattern of the leg 43 is prepared. The mask is arranged over the material for the core 42b. Then, light irradiation is performed from above the mask. At this time, the material for the core 42b on the upper surface of the base member 41 and the material for the leg 43 on the lower surface of the base member 41 are irradiated with the light having passed through the openings. The irradiated portions are cured. The upper and lower surfaces of the base member 41 are developed. As a result, the core 42b and the leg 43 are simultaneously formed on the portions having been irradiated with the light. By forming the core 42b and the leg 43 at the same time, relative positional accuracy between the core 42b and the leg 43 may be further enhanced.

Then, a material for the upper cladding layer 42c is adhered to cover the lower cladding layer 42a and the core 42b. Examples of the material for the upper cladding layer 42c include a resin film made of an epoxy resin, a polyimide resin or the like, and a resin paste. After the adhesion of such a material, masking, exposure, and development are performed as necessary to form the upper cladding layer 42c.

A step of forming the wiring board 3 will be described. The insulating plate 31 is prepared first. The insulating plate 31 is not particularly limited as long as it is made of a material having an insulating property such as an epoxy resin or a bismaleimide-triazine resin, as described above. As described above, the insulating plate 31 may have a single-layer structure including only a core layer or may have a build-up structure in which an insulation layer and an electrical conductor layer are alternately layered on at least one surface of the core layer having an insulating property. A through-hole conductor used for electrically connecting the upper and lower surfaces of the insulating plate 31, a via-hole conductor used for electrically connecting layers in the build-up structure, and the like may be formed.

Then, the support member 33 for supporting the leg 43 included in the optical waveguide plate 4 and the electrode 32 for mounting the optical component 5 are formed on the upper surface of the insulating plate 31. The electrode 32 and the support member 33 are made of a metal such as copper, for example, a metal foil such as a copper foil or metal plating such as copper plating. As described above, the support member 33 is not always necessary, and may be provided as appropriate when the length of the leg 43 needs to be shortened, or the like.

Then, a photosensitive material for the solder resist 34 is adhered on the upper surface of the insulating plate 31 to cover the support member 33 and the electrode 32. Examples of the material for the solder resist 34 include a resin paste and a resin film made of an acrylic-modified epoxy resin or the like. After the adhesion of the above-discussed material, masking is performed to protect portions where the first opening 341 for exposing the support member 33 and the second opening 342 for exposing the electrode 32 are to be formed from being irradiated with light. Thereafter, exposure and development are performed to form the solder resist 34. The first opening 341 functions as the fitting portion 35, into which the leg 43 of the optical waveguide plate 4 is inserted. The second opening 342 functions as the connecting portion 36 configured to connect the electrode 32 and an electrode 52 of the optical component 5 with the solder 6. By forming the first opening 341 and the second opening 342 at the same time, relative positional accuracy between the first opening 341 and the second opening 342 may be further enhanced. In other words, the optical circuit board 2 having high relative positional accuracy between the fitting portion 35 mounted with the optical waveguide plate 4 and the connecting portion 36 mounted with the optical component 5 may be formed.

The leg 43 included in the optical waveguide plate 4 is inserted into the fitting portion 35 to be brought into contact with the support member 33, whereby the optical waveguide plate 4 is mounted on the wiring board 3. In order to strengthen the connection between the optical waveguide plate 4 and the wiring board 3, the leg 43 and the fitting portion 35 may be reinforced by using an adhesive. In the manner described above, the optical circuit board 2 according to the embodiment may be achieved. By mounting the optical component 5 on the optical circuit board 2 discussed above, the mounting structure 1 excellent in relative positional accuracy between the optical waveguide plate 4 and the optical component 5 may be provided.

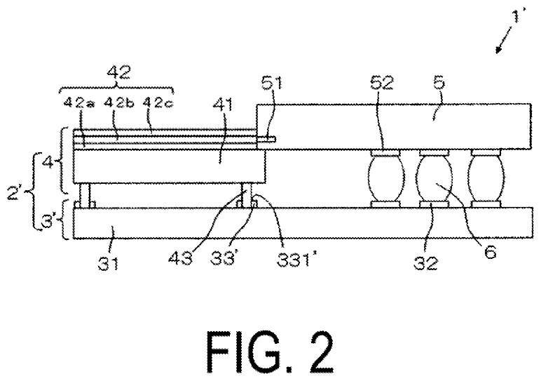

An optical circuit board according to another embodiment of the present disclosure will be described based on FIG. 2. FIG. 2 is an explanatory diagram illustrating a mounting structure 1′ including an optical circuit board 2′ according to another embodiment of the present disclosure. The optical circuit board 2′ according to the other embodiment illustrated in FIG. 2 includes a wiring board 3′ and an optical waveguide plate 4. With regard to members used in the mounting structure 1′ illustrated in FIG. 2, the same members as those of the mounting structure 1 illustrated in FIG. 1A are denoted by the same reference signs, and detailed description thereof will be omitted.

In the wiring board 3 included in the mounting structure 1 according to the embodiment illustrated in FIG. 1A, the solder resist is formed on the upper surface of the insulating plate 31. On the other hand, the wiring board 3′ is different from the wiring board 3 in that no solder resist is formed on an upper surface of an insulating plate 31′ in the wiring board 3′ included in the mounting structure 1′ according to the another embodiment illustrated in FIG. 2.

A fitting portion 35′ having a third opening 331′ for fitting a leg 43 of the optical waveguide plate 4 is located on the upper surface of the insulating plate 31′. By inserting the leg 43 into the third opening 331′ of the fitting portion 35′, the optical waveguide plate 4 is easily mounted at a predetermined position on the wiring board 3′. By fitting the leg 43 into the third opening 331′, the optical waveguide plate 4 is unlikely to be detached from the wiring board 3′.

The fitting portion 35′ and an electrode 32 are simultaneously formed by plating, for example. Specifically, for example, electroless copper plating is performed on the surface of the insulating plate 31′. A plating resist having openings corresponding to the patterns of the fitting portion 35′ and the electrode 32 in a plan view is adhered on the electroless copper plating surface. Thereafter, electrolytic copper plating is performed to precipitate copper plating in the openings. Finally, the plating resist is removed to remove the electroless copper plating present under the plating resist, thereby simultaneously forming the fitting portion 35′ and the electrode 32 to become a bonding portion 36′. By forming the fitting portion 35′ and the bonding portion 36′ (electrode 32) at the same time, relative positional accuracy between the fitting portion 35′ and the bonding portion 36′ (electrode 32) may be further enhanced. In other words, the optical circuit board 2 having high relative positional accuracy between the fitting portion 35′ mounted with the optical waveguide plate 4 and the bonding portion 36′ mounted with an optical component 5 may be formed. By mounting the optical component 5 on the optical circuit board 2 discussed above, the mounting structure 1′ excellent in relative positional accuracy between the optical waveguide plate 4 and the optical component 5 may be provided.

The optical circuit board and the mounting structure of the present disclosure are not limited to the embodiment described above. In the above-described embodiment, the leg 43 included in the optical waveguide plate 4 has a cylindrical shape having a constant diameter as illustrated in FIGS. 1A, 1B, and 2.

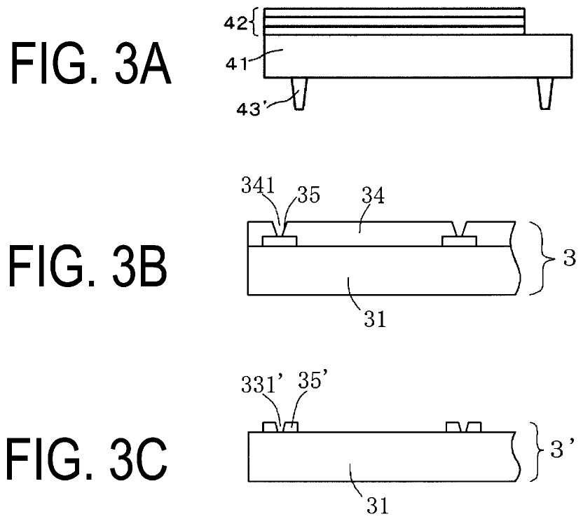

However, the optical waveguide plate may include a leg 43′ as illustrated in FIG. 3A, for example. The leg 43′ has a shape that continuously tapers as a distance from a base member 41 increases. In the case where the optical waveguide plate includes the leg 43′ as illustrated in FIG. 3A, a first opening formed in a solder resist included in a wiring board has a shape that continuously widens as the distance from an insulating plate increases while corresponding to the shape of the leg 43′ as illustrated in FIG. 3B. In the case where a wiring board including no solder resist is used, a third opening formed in a support member has a shape that continuously widens as the distance from an insulating plate increases while corresponding to the shape of the leg 43′ as illustrated in FIG. 3C.

The shape of the leg is not limited to a circular shape in a top surface view of a cross section thereof. For example, the shape of the leg may take a polygonal shape such as a triangular shape or a quadrilateral shape, an elliptical shape, an L shape, or the like in the top surface view of the cross section thereof. For example, when the leg has an L shape in the top surface view of the cross section thereof, the leg is unlikely to come off from the first opening and the third opening. The first opening and the third opening are also appropriately formed in accordance with the shape of the leg.

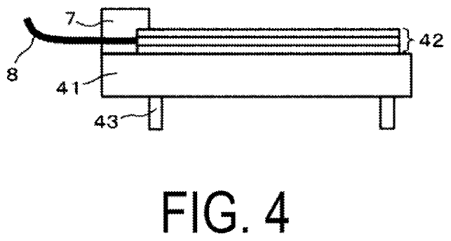

As illustrated in FIG. 4, the optical waveguide plate may include a connector 7 for connecting with an optical fiber 8. Since the optical waveguide plate includes the connector 7, an optical signal transmission/reception test including the connector 7 and an optical waveguide 42 may be carried out before mounting the optical waveguide plate on a wiring board. This makes it possible to reduce the occurrence of defects in the optical circuit board, and to reduce wastage of the wiring board due to the occurrence of defects.

### REFERENCE SIGNS

1, 1′ Mounting structure

2, 2′ Optical circuit board

3, 3′ Wiring board

31 Insulating plate

32 Electrode

33, 33′ Support member

35, 35′ Fitting portion

331′ Third opening

34 Solder resist

341 First opening

342 Second opening

4 Optical waveguide plate

41 Base member

42 Optical waveguide

42a Lower cladding layer

42b Core

42c Upper cladding layer

43, 43′ Leg

5 Optical component

51 Light transmitting/receiving portion

52 Electrode

6 Solder

7 Connector

8 Optical fiber

1. An optical circuit board to be mounted with an optical component, the optical circuit board comprising:
an optical waveguide plate comprising a base member, an optical waveguide located on an upper surface of the base member, and a leg located on a lower surface of the base member; and
a wiring board comprising an insulating plate, a fitting portion located on an upper surface of the insulating plate for fitting with the leg, and an electrode located on the upper surface of the insulating plate and to be electrically connected to the optical component, wherein
the leg of the optical waveguide plate is fitted into the fitting portion of the wiring board, and
a gap is present between a lower surface of the optical waveguide plate and an upper surface of the wiring board.

2. The optical circuit board according to claim 1, wherein a solder resist comprising a first opening to serve as the fitting portion and a second opening to expose the electrode is located on the upper surface of the insulating plate.

3. The optical circuit board according to claim 2, wherein the leg has a shape that continuously tapers as a distance from the base member increases, and the first opening has a shape that continuously widens as a distance from the insulating plate increases.

4. The optical circuit board according to claim 1, wherein an electrical conductor comprising a third opening to serve as the fitting portion is located on the upper surface of the insulating plate.

5. The optical circuit board according to claim 4, wherein
the leg has a shape that continuously tapers as a distance from the base member increases, and
the third opening has a shape that continuously widens as a distance from the insulating plate increases.

6. The g optical circuit board according to claim 1, wherein the leg has an L-shaped cross section in a top surface view.

7. The optical circuit board according to claim 1, wherein
at least part of a peripheral edge portion of the base member is exposed without being covered with the optical waveguide in a top surface view of the optical waveguide plate.

8. The optical circuit board according to claim 1, wherein
the base member has optical transparency.

9. The optical circuit board according to claim 1, wherein the optical waveguide plate further comprises a connector for connecting with an optical fiber.

10. A mounting structure, comprising:
the optical circuit board according to claim 1; and
an optical component comprising a light transmitting/receiving portion on at least one side surface, wherein
the optical component is connected to an electrode of the optical circuit board via solder, and
a lower surface on a bottom side of the light transmitting/receiving portion is in contact with the upper surface of the base member of the optical waveguide plate.

11. A method for manufacturing an optical circuit board to be mounted with an optical component, the method comprising:
forming an optical waveguide plate, comprising,
preparing a base member having optical transparency,
forming a lower cladding layer on an upper surface of the base member,
adhering a core material having photosensitivity on an upper surface of the lower cladding layer,
adhering a leg material having photosensitivity on a lower surface of the base member,
forming a core by causing the core material to be irradiated with light, and forming a leg by causing the leg material to be irradiated with light having passed through the base member, and
forming an upper cladding layer covering the lower cladding layer and the core;
forming a wiring board, comprising
preparing an insulating plate,
forming, on an upper surface of the insulating plate, an electrode to be electrically connected to the optical component,
adhering, on the upper surface of the insulating plate, a solder resist material having photosensitivity and covering the electrode, and
forming a solder resist in which a first opening to serve as a fitting portion for fitting with the leg and a second opening to expose the electrode to a bottom portion are formed simultaneously, by performing exposure and development on the solder resist material; and
mounting the optical waveguide plate on the wiring board, the leg being inserted into the fitting portion and a gap being present between a lower surface of the optical waveguide plate and an upper surface of the wiring board.

12. A method for manufacturing an optical circuit board to be mounted with an optical component, the method comprising:
forming an optical waveguide plate, comprising,
preparing a base member having optical transparency,
forming a lower cladding layer on an upper surface of the base member,
adhering a core material having photosensitivity on an upper surface of the lower cladding layer,
adhering a leg material having photosensitivity on a lower surface of the base member,
forming a core by causing the core material to be irradiated with light, and forming a leg by causing the leg material to be irradiated with the light having passed through the base member, and
forming an upper cladding layer covering the lower cladding layer and the core;
forming a wiring board, comprising
preparing an insulating plate, and
forming an electrical conductor comprising a third opening to serve as a fitting portion for fitting with the leg and an electrode to be electrically connected to the optical component simultaneously on an upper surface of the insulating plate; and
mounting the optical waveguide plate on the wiring board, the leg being inserted into the fitting portion and a gap being present between a lower surface of the optical waveguide plate and an upper surface of the wiring board.
